(19) United States
(12) Patent Application Publication
(10) Pub. No.: US 2020/0347183 A1
(43) Pub. Date: Nov. 5, 2020

(54) SILANE-MODIFIED POLYUREA COMPOUNDS BASED ON POLYISOCYANATES HAVING ISOCYANURATE AND ALLOPHANATE GROUPS

(71) Applicant: Covestro Deutschland AG, Leverkusen (DE)

(72) Inventors: Thomas FULSCHE, Langenfeld (DE); Thomas SCHÜTTLER, Köln (DE); Marianne STRUWE, Langenfeld (DE); Matthias WINTERMANTEL, Hürth (DE); Jürgen KÖCHER, Langenfeld (DE)

(21) Appl. No.: 16/958,701

(22) PCT Filed: Dec. 12, 2018
(86) PCT No.: PCT/EP2018/084555

§ 371 Date: Jun. 27, 2020

(30) Foreign Application Priority Data
Dec. 28, 2017 (EP) 17210829.2

(51) Int. Cl. C08G 71/02; C09D 175/02

(52) U.S. Cl. CPC C08G 71/02; C09D 175/02

(57) ABSTRACT

The invention relates to a polyurea compound that can be produced by reacting a polyisocyanate based on isophorone diisocyanate, which has isocyanurate and allophanate groups, with an amino silane according to general formula (I): R¹ₐ(R¹O)₍₃₋ₐ)Si(CH₂)ₙNHCHR²CH₂COOR³ (I), wherein the groups R¹ are selected independently from one another from C₁-C₂₀-alkyl or C₆-C₂₀-aryl, a is a whole number between 0 and 2, n is a whole number between 1 and 4, R² is selected from H, C₁-C₂₀-alkyl, C₆-C₁₂-aryl and —COOR³, and R³ is a respective C₁-C₂₀-alkyl. The invention also relates to the use of the compound as a binder for producing coatings.

### FIELD OF THE INVENTION

The present invention relates to silane-modified polyurea compounds based on polyisocyanates having isocyanurate and allophanate groups and to the use of same as binders in coatings, in particular in the field of corrosion protection.

### PRIOR ART

The use of alkoxysilane-modified polyurea compounds as binders in coatings is known. The compounds have terminal alkoxysilane groups which have the property of hydrolyzing on contact with small amounts of moisture to give organosilanols and of polymerizing via subsequent condensation to give organosiloxanes. This polymerization leads to a crosslinking of the silane-modified polyurea compound, also referred to as curing. On account of this capability for further crosslinking, silane-modified polyurea compounds are also referred to as silane-terminated prepolymers (STP) and are suitable as binders for moisture-curing coatings.

EP 0949 284 A1 describes silane-modified polyisocyanates having a content of free isocyanate groups of 0.2% to 20% by weight. These polyisocyanates are suitable as binders in combination with an isocyanate-reactive component to produce two-component coatings, adhesives and sealants. The presence of free isocyanate groups is required for the use in two-component systems. However, due to the high reactivity of free isocyanate groups, these compounds and compositions containing these compounds present a possible toxicological hazard for the user. For this reason, there is a need for isocyanate-free binders.

EP 0 924 231 A1 describes aqueous dispersions of polyurethane/polyurea compounds based on polyisocyanates which have been reacted with polyols and aminosilanes. In order to ensure dispersibility in water, the compounds preferably have additional anionic groups. These compounds may for example be used as binders for coatings, adhesives and sealants. Use in anticorrosion systems, in particular in non-aqueous topcoat coatings, is not disclosed.

DE 10 2012 204 298 A1 describes binders based on polyisocyanates which are reacted with secondary aminosilanes to give silane-modified polyurea compounds. Aminosilanes used here are secondary N-alkyl-, N-cycloalkyl- or N-arylaminoalkoxysilanes. Polyisocyanates used are aliphatic or cycloaliphatic, monomeric or oligomeric polyisocyanates. As a result of the virtually quantitative reaction of the polyisocyanate with the aminosilane, these binders contain a very low content of free isocyanate groups. The combination of these binders with specific curing catalysts enables the production of coatings having a high mechanical stability.

WO 2012/002932 A1 describes one-component coatings for use in shipbuilding. These coatings feature a high UV stability. The coatings contain a binder based on polyisocyanates which are re-acted with secondary aminosilanes to give silane-modified polyurea compounds. As in DE 10 2012 204 298 A1, the aminosilanes used are secondary N-alkyl-, N-cycloalkyl- or N-arylaminoalkoxysilanes. Likewise, polyisocyanates used are aliphatic or cycloaliphatic, monomeric or oligomeric polyisocyanates.

The binders disclosed in DE 10 2012 204 298 A1 and WO 2012/002932 A1 basically meet the demands on isocyanate-free binders and are suitable for use in coatings, in particular as topcoat in an anticorrosion system. However, there is still a need for coatings having improved technical properties.

In particular, there is a need for fast-curing binders having a markedly shortened drying time (e.g. measured as drying level T1 and T6 in accordance with DIN EN ISO 9117/5). This is a need in particular, but not exclusively, for ethoxysilane-modified binders which due to their low toxicological potential are generally preferred but which cure more slowly than comparable methoxysilane-modified binders.

### DESCRIPTION OF THE INVENTION

For this reason, it is an object of the invention to provide a fast-curing binder for use in coatings. The binder is intended to be suitable particularly for use in a topcoat of an anticorrosion system. Moreover, the invention is to provide an isocyanate-free and in this respect toxicologically harmless binder. The material should preferably also not release any methanol during the curing.

Silane-Modified Polyurea Compound

This object is achieved by a silane-modified polyurea compound preparable via reaction of a polyisocyanate based on isophorone diisocyanate and having isocyanurate and allophanate structural units

with an aminosilane of general formula (I)

R¹ₐ(R¹O)₍₃₋ₐ₎Si(CH₂)ₙNHCHR²CH₂COOR³ (I)

where the radicals R¹ independently of one another are selected from C₁-C₂₀-alkyl or C₆-C₂₀-aryl,

a is an integer between 0 and 2,

n is an integer between 1 and 4,

R² is selected from H, C₁-C₂₀-alkyl, C₆-C₁₂-aryl and —COOR³, and

R³ in each case is C₁-C₂₀-alkyl.

The compounds according to the invention are distinguished by a novel combination of polyisocyanate and aminosilane and are especially suitable as binders for coatings. The use of the compounds according to the invention as binders surprisingly leads to an improved development of hardness of the coating. This manifests itself, inter alia, in a faster development of the pendulum hardness (for example measured using a Konig pendulum damping instrument according to DIN EN ISO 1522:2007-04) and a faster through drying of the coating (for example measured as drying level T1 and T6 in accordance with DIN EN ISO 9117/5). In addition, compared to binders which are based on N-alkyltrialkoxyaminosilanes, the compounds according to the invention have a lower viscosity with a simultaneously higher polymer content. The products according to the invention therefore require less solvent to set a required low viscosity than the compounds based on N-alkyltrialkoxyaminosilanes. The invention thus meets the demand for low solvent amounts, a demand which is constantly growing in all areas of the coatings industry.

It has been found that this effect can be attributed to the combination according to the invention of an IPDI-based oligomeric polyisocyanate having isocyanurate and allophanate groups with an aminosilane of formula (I). The binder according to the invention in terms of its action outperforms in particular those binders which are based on other aliphatic polyisocyanates, such as for instance oligomeric polyisocyanates having isocyanurate groups and based on hexamethylene diisocyanate (HDI).

The compounds according to the invention have a low content of free isocyanate groups. The compounds according to the invention are therefore toxicologically harmless and easy to handle. The content of free isocyanate groups is preferably less than 0.2% by weight, particularly preferably less than 0.01% by weight, most preferably less than 0.001% by weight. Ideally, the compounds do not have any free isocyanate groups within the precision of detection. The content of free isocyanate groups can be determined in accordance with DIN EN ISO 11909:2007-05.

The compounds according to the invention additionally feature a high proportion of silane groups, based on the weight of the compound. This improves the curing properties of coating compositions which comprise the compounds according to the invention as binders. The compounds according to the invention are therefore suitable in particular for the production of quick-drying coatings.

The proportion of silane groups based on the weight of the compound is typically reported as the proportion of silicon based on the weight of the compound and is preferably 0.1% to 10% by weight, preferably 1% to 7% by weight, most preferably 1.5% to 5% by weight. The silicon content may for example be calculated from the amount of the aminosilane used to prepare the compound according to the invention. The silicon content may also be determined by way of inductively coupled plasma atomic emission spectrometry (ICP-OES).

The compounds preferably have a number-average molecular weight of 300 to 6000 g/mol, preferably 800 to 4000 g/mol, particularly preferably 1000 to 3000 g/mol, most preferably 1000 to 2000 g/mol. The weight-average molecular weight is preferably 500 to 5000 g/mol, preferably 800 to 3000 g/mol, particularly preferably 1000 to 3000 g/mol. The number-average/weight-average molecular weight can be ascertained by means of gel permeation chromatography (GPC) in accordance with DIN 55672-1:2016-03 using THF as eluent against a polystyrene standard.

Additional Alcohols and Amines

The compounds preferably have further urea/urethane groups which are obtainable via reaction of a portion of the isocyanate groups of the polyisocyanate with a dialkylamine/an alcohol. The proportion of silane-modified end groups can be adjusted in this way.

Alcohols contemplated here are preferably aliphatic alcohols having 1 to 20 carbon atoms. Within the context of this invention, this also includes alkoxylated alcohols comprising ether groups. Particular preference is given to aliphatic alcohols having 1 to 16 carbon atoms. The alcohols are particularly preferably monoalcohols. Examples of suitable alcohols are methanol, ethanol, n- and isopropanol, n-butanol, ethylene glycol monobutyl ether, 2-ethylhexanol, 1-octanol, 1-dodecanol, 1-hexadecanol.

Crosslinking Polyols

The alcohols used can also be polyols, which may result in a pre-crosslinking of the polyisocyanate molecules. However, the compound according to the invention is preferably an uncrosslinked compound and no polyols are used.

Polyols that can be used preferably have a number-average molecular weight Mₙ of 400 to 8000 g/mol, preferably of 400 to 6000 g/mol and particularly preferably of 400 to 3000 g/mol. The hydroxyl number thereof is preferably 22 to 700 mg KOH/g, preferably 30 to 300 mg KOH/g and particularly preferably 40 to 250 mg KOH/g. The polyols preferably have an OH functionality of 1.5 to 6, preferably of 1.7 to 5 and particularly preferably of 1.8 to 5.

Polyols that can be used are the organic polyhydroxyl compounds known in polyurethane coating technology, for example the standard polyester polyols, polyacrylate polyols, polyurethane polyols, polycarbonate polyols, polyether polyols, polyester polyacrylate polyols and polyurethane polyacrylate polyols, polyurethane polyester polyols, polyurethane polyether polyols, polyurethane polycarbonate polyols, polyester polycarbonate polyols, phenol/formaldehyde resins, alone or in mixtures. Preference is given to polyester polyols, polyether polyols, polyacrylate polyols or polycarbonate polyols, particular preference is given to polyether polyols, polyester polyols and polycarbonate polyols.

Polyether polyols include, for example, the polyaddition products of the styrene oxides, of ethylene oxide, of propylene oxide, of tetrahydrofuran, of butylene oxide, of epichlorohydrin, and the mixed addition and grafting products thereof, and the polyether polyols obtained by condensation of polyhydric alcohols or mixtures thereof and those obtained by alkoxylation of polyhydric alcohols, amines and amino alcohols.

Suitable hydroxy-functional polyethers have OH functionalities of 1.5 to 6.0, preferably 1.8 to 5, OH numbers of 22 to 700 and preferably of 40 to 600 mg KOH/g of solids, and molecular weights Mₙ of 106 to 4000 g/mol, preferably of 200 to 3500, for example alkoxylation products of hydroxy-functional starter molecules such as ethylene glycol, propylene glycol, butanediol, hexanediol, trimethylolpropane, glycerol, pentaerythritol, sorbitol or mixtures of these and also other hydroxy-functional compounds with propylene oxide or butylene oxide. Preferred polyether components are polypropylene oxide polyols, polyethylene oxide polyols and polytetramethylene oxide polyols.

Examples of polyester polyols that are of good suitability are the polycondensates, known per se, of di- and optionally tri- and tetraols and di- and optionally tri- and tetracarboxylic acids or hydroxycarboxylic acids or lactones. Instead of the free polycarboxylic acids, it is also possible to use the corresponding polycarboxylic anhydrides or corresponding polycarboxylic esters of lower alcohols to prepare the polyesters. Examples of suitable diols are ethylene glycol, butylene glycol, diethylene glycol, triethylene glycol, polyalkylene glycols such as polyethylene glycol, and also propane-1,2-diol, propane-1,3-diol, butane-1,3-diol, butane-1,4-diol, hexane-1,6-diol and isomers, neopentyl glycol or neopentyl glycol hydroxypivalate, preference being given to the three latter compounds. In order to achieve a functionality >2, it is optionally possible to use proportions of polyols having a functionality of 3, for example trimethylolpropane, glycerol, erythritol, pentaerythritol, trimethylolbenzene or trishydroxyethyl isocyanurate.

Useful dicarboxylic acids include, for example, phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, 2,2-dimethylsuccinic acid. Anhydrides of these acids are likewise usable, where they exist. For the purposes of the present invention, the anhydrides are consequently covered by the expression “acid”. It is also possible to use monocarboxylic acids such as benzoic acid and hexanecarboxylic acid, provided that the mean functionality of the polyol is ≥2. Saturated aliphatic or aromatic acids are preferred, such as adipic acid or isophthalic acid. One example of a polycarboxylic acid for optional additional use in smaller amounts is trimellitic acid.

Examples of hydroxycarboxylic acids that may be used as co-reactants in the preparation of a polyester polyol having terminal hydroxyl groups include hydroxycaproic acid, hydroxybutyric acid, hydroxydecanoic acid, hydroxystearic acid and the like. Usable lactones include ε-caprolactone, butyrolactone and homologs.

Preference is given to polyester polyols based on butanediol and/or neopentyl glycol and/or hexanediol and/or ethylene glycol and/or diethylene glycol with adipic acid and/or phthalic acid and/or isophthalic acid. Particular preference is given to polyester polyols based on butanediol and/or neopentyl glycol and/or hexanediol with adipic acid and/or phthalic acid.

Possible usable polyesters are also polycaprolactone polyols as are commercially available from Perstorp in the form of CAPA polycaprolactone polyols.

The useful polycarbonate polyols are obtainable by reaction of carbonic acid derivatives, for example diphenyl carbonate, dimethyl carbonate or phosgene, with diols. Useful diols of this kind include, for example, ethylene glycol, propane-1,2- and 1,3-diol, butane-1,3- and 1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A, tetrabromobisphenol A, but also lactone-modified diols.

Preferably, the diol component contains 40% to 100% by weight of hexane-1,6-diol and/or hexanediol derivatives, preferably those having not only terminal OH groups but also ether or ester groups, for example products which are obtained by reaction of 1 mol of hexanediol with at least 1 mol, preferably 1 to 2 mol, of ε-caprolactone, or by etherification of hexanediol with itself to give di- or trihexylene glycol. It is also possible to use polyether polycarbonate polyols.

Preference is given to polycarbonate polyols based on dimethyl carbonate and hexanediol and/or butanediol and/or ε-caprolactone. Very particular preference is given to polycarbonate polyols based on dimethyl carbonate and hexanediol and/or ε-caprolactone.

Instead of the above-described polymeric polyether, polyester or polycarbonate polyols, it is also possible to use low molecular weight polyols in the molar mass range from 62-400 g/mol for the preparation of the compounds according to the invention. Suitable low molecular weight polyols are short-chain, i.e. containing 2 to 20 carbon atoms, aliphatic, araliphatic or cycloaliphatic diols or triols. Examples of diols are ethylene glycol, diethylene glycol, triethylene glycol, tetraethylene glycol, dipropylene glycol, tripropylene glycol, propane-1,2-diol, propane-1,3-diol, butane-1,4-diol, neopentyl glycol, 2-ethyl-2-butylpropanediol, trimethylpentanediol, 2,2,4-trimethylpentane-1,3-diol, positionally isomeric diethyloctanediols, 1,3-butylene glycol, cyclohexanediol, cyclohexane-1,4-dimethanol, hexane-1,6-diol, cyclohexane-1,2- and -1,4-diol, hydrogenated bisphenol A (2,2-bis(4-hydroxycyclohexyl)propane), 2,2-dimethyl-3-hydroxypropyl 2,2-dimethyl-3-hydroxypropionate. Preference is given to butane-1,4-diol, cyclohexane-1,4-dimethanol and hexane-1,6-diol. Examples of suitable triols are trimethylolethane, trimethylolpropane or glycerol, preference being given to trimethylolpropane.

The stated polyols can be used alone or in a mixture.

The dialkylamine used can preferably be a compound of the formula NH(R⁴)₂, where R⁴ in each case is C₁-C₆-alkyl. A particularly preferred dialkylamine is di-n-butylamine.

Polyisocyanates

The compounds are based on a polyisocyanate based on isophorone diisocyanate and having isocyanurate and allophanate groups. This is an oligomeric polyisocyanate which is prepared starting from isophorone diisocyanate by means of methods known per se. A portion of the isocyanate groups present in the isophorone diisocyanate are subjected to a trimerization reaction in the presence of a suitable catalyst. An alkanol is added to the reaction mixture before, during and/or following the trimerization, so that a portion of the isocyanate groups react with the alkanol via the corresponding urethane stage to give the allophanate. The details of this preparation process are known to those skilled in the art and by way of example are disclosed in EP 0 649 866 A1.

The alkanol used here is preferably an aliphatic alcohol having 1 to 6 carbon atoms or mixtures of these alcohols. Examples of suitable alcohols are methanol, ethanol, n- and isopropanol, n-butanol, n-pentanol, 2-ethyl-1-hexanol, 1-octanol, 1-dodecanol, 1-hexadecanol. n-Butanol, n-pentanol and 2-ethyl-1-hexanol are particularly preferred. A mixture comprising n-butanol is preferably used. A mixture comprising n-butanol and n-pentanol is particularly preferably used.

The polyisocyanate preferably has a content of isocyanate groups of 8% to 20% by weight, preferably 10% to 18% by weight, particularly preferably 10% to 15% by weight.

The polyisocyanate preferably has a content of isocyanurate groups, calculated as C₃N₃O₃ (molecular weight 126 g/mol), of 3.5% to 24% by weight, preferably 7% to 17% by weight.

The polyisocyanate preferably has a content of allophanate groups, calculated as C₂HN₂O₃ (molecular weight 101 g/mol), of 2.5% to 23% by weight, preferably 5% to 16% by weight.

The polyisocyanate preferably has a total content of isocyanate groups, isocyanurate groups and allophanate groups of 28% to 51% by weight.

A particularly suitable polyisocyanate is commercially available under the Desmodur XP 2565 trade name.

The polyisocyanate to be used according to the invention, based on isophorone diisocyanate and having isocyanurate and allophanate groups, may also be used in the form of a mixture comprising further polyisocyanates. The proportion of pure polyisocyanate based on isophorone diisocyanate and having isocyanurate and allophanate groups in this mixture is by preference at least 50% by weight, preferably at least 60% by weight, most preferably at least 75% by weight, in each case based on the total amount of pure polyisocyanate.

Aminosilanes

The compounds comprise silane groups which have been derived from secondary aminosilanes of general formula (I).

The compounds preferably comprise ethoxy or methoxysilane groups. The radicals R¹ are accordingly preferably ethyl or methyl. The radicals R¹ are particularly preferably ethyl.

The compounds preferably comprise dialkoxy- or trialkoxysilane groups. Accordingly, a is preferably 0 or 1.

The aminosilanes of formula (I) are particularly preferably aminopropylsilanes with n=3.

The aminosilanes of formula (I) are preferably secondary aminosilanes which can be obtained by reaction of a primary aminosilane with esters of maleic acid, fumaric acid or cinnamic acid.

Accordingly, R² is preferably C₆-C₁₂-aryl or —COOR³, particularly preferably phenyl or —COOR³. R² is most preferably —COOR³.

The radical R³ is preferably a C₁-C₆-alkyl, for example methyl, ethyl, n- or isopropyl, n-butyl, iso-butyl, sec-butyl, tert-butyl, n-pentyl, 2-pentyl or 3-pentyl. R³ is most preferably ethyl or methyl.

Preparation Process

The invention also relates to a process for preparing the polyurea compound according to the invention by

a) providing a polyisocyanate based on isophorone diisocyanate and having isocyanurate and allophanate groups,

b) reacting at least a portion of the NCO groups of the polyisocyanate with an aminosilane of general formula (I)

R¹ₐ(R¹O)₍₃₋ₐ₎Si(CH₂)ₙNHCHR²CH₂COOR³ (I)

where the radicals R¹ independently of one another are selected from C₁-C₂₀-alkyl or C₆-C₂₀-aryl,

a is an integer between 0 and 2,

n is an integer between 1 and 4,

R² is selected from H, C₁-C₂₀-alkyl, C₆-C₁₂-aryl and —COOR³, and

R³ in each case is C₁-C₂₀-alkyl,

c) optionally reacting a portion of the NCO groups of the polyisocyanate with a dialkylamine or an alcohol,

wherein steps b) and c) can be performed simultaneously or in succession in any desired sequence.

The reaction in steps b) and c) are effected in the liquid phase, optionally in the presence of an additional solvent. The reaction of polyisocyanates with aminosilanes is known in principle to those skilled in the art. The reaction of the NCO groups of the polyisocyanate with the aminosilane or with the dialkylamine is preferably effected at a temperature of less than 130° C., preferably in the range from 30 to 80° C. The reaction of the NCO groups of the polyisocyanate with the alcohol is preferably conducted at temperatures from 20° C. to 200° C., preferably 40° C. to 140° C. and particularly preferably from 60° C. to 120° C. The solvent added is preferably 1-methoxy-2-propyl acetate or butyl acetate.

The free NCO groups can be reacted with the dialkylamine without catalysis.

As described above, the alcohol used can be a monoalcohol or a polyol. A monoalcohol is preferably used. The reaction of the free NCO groups with monoalcohols or polyols to give urethane groups can be effected without catalysis, but is preferably accelerated by catalysis. Useful urethanization catalysts for accelerating the NCO—OH reaction are those known per se to those skilled in the art such as for example organotin compounds, bismuth compounds, zinc compounds, titanium compounds, zirconium compounds or aminic catalysts.

In the preparation process, this catalyst component, if used, is used in amounts from 0.001% by weight to 5.0% by weight, preferably 0.005% by weight to 2% by weight and particularly preferably 0.01% by weight to 1% by weight, based on the solids content of the process product.

The reaction is preferably continued until complete conversion of the isocyanate-reactive groups has been achieved. The progress of the reaction is expediently monitored by checking the NCO content and is ended when the corresponding theoretical NCO content has been reached and is constant. This can be monitored by suitable measuring instruments installed in the reaction vessel and/or using analyses of withdrawn samples. Suitable processes are known to those skilled in the art. These are for example, viscosity measurements, measurements of the NCO content, of the refractive index, of the OH content, gas chromatography (GC), nuclear magnetic resonance spectroscopy (NMR), infrared spectroscopy (IR) and near near-infrared spectroscopy (NIR). The NCO content of the mixture is preferably determined by titrimetric means.

It is unimportant whether the process is conducted continuously, for example in a static mixer, extruder or kneader, or batchwise, for example in a stirred reactor. The process is preferably conducted in a stirred reactor.

Coatings

The invention also relates to a moisture-curing coating comprising the polyurea compound according to the invention and a crosslinking catalyst. The coating according to the invention is preferably a topcoat for an anticorrosion system.

The proportion of the polyurea compound according to the invention in the coating is by preference 10% to 80% by weight, preferably 20% to 70% by weight, particularly preferably 30% to 60% by weight, based on the total weight of the coating.

Crosslinking Catalyst

Within the context of this invention, a crosslinking catalyst refers to a compound which in the presence of water catalyzes the condensation reaction of the alkoxysilane groups of the polyurea compound according to the invention. Crosslinking catalysts used can be the catalysts known in the prior art. The catalyst may for example be a metal catalyst or a phosphorus-containing and/or nitrogen-containing compound.

Suitable metal catalysts preferably comprise a metal selected from Zn, Sn, Ti, Zr and Al. They are preferably organozinc compounds, organotin compounds, organotitanates, organozirconates and organoaluminates. The organotitanates, organozirconates and organoaluminates preferably have ligands which are selected from an alkoxy group, sulfonate group, carboxylate group, dialkylphosphate group, dialkylpyrophosphate group and acetylacetonate group, where all ligands may be identical or different from each other. Suitable metal catalysts have been described by way of example in US 2016/0244606 A1.

Examples of suitable phosphorus-containing catalysts are substituted phosphonic diesters and diphosphonic diesters, preferably from the group consisting of acyclic phosphonic diesters, cyclic phosphonic diesters, acyclic diphosphonic diesters and cyclic diphosphonic diesters. Catalysts of this kind have been described by way of example in the German patent application DE-A-102005045228.

In particular, however, substituted phosphoric monoesters and phosphoric diesters are used, preferably from the group consisting of acyclic phosphoric diesters and cyclic phosphoric diesters, particularly preferably amine adducts of phosphoric monoesters and diesters.

Acidic catalysts such as sulfonic acids are also usable as catalysts, as described in DE 102012204298. In addition, carboxylates can also be used, as likewise described in DE 102012204298.

Catalysts used are very particularly preferably the corresponding amine-blocked phosphoric esters, and here in particular amine-blocked ethylhexyl phosphates and amine-blocked phenyl phosphates, very particularly preferably amine-blocked bis(2-ethylhexyl) phosphates.

Suitable examples of amines used to block the phosphoric esters include in particular tertiary amines, for example bicyclic amines, such as for example diazabicyclooctane (DABCO), 5-diazabicyclo[4.3.0]non-5-ene (DBN), 1,8-diazabicyclo [5.4.0]undec-7-ene (DBU), dimethyldodecylamine or triethylamine.

Suitable nitrogen-containing catalysts are for example amidines; amines such as in particular N-ethyldiisopropylamine, N,N,N′,N′-tetramethylalkylenediamines, polyoxyalkyleneamines, 1,4-diazabicyclo[2.2.2]octane; aminosilanes such as 3-aminopropyltrimethoxysilane, 3-aminopropyldimethoxymethylsilane, N-(2-aminoethyl)-3-aminopropyltrimethoxysilane, N-(2-aminoethyl)-3-aminopropylmethyldimethoxysilane, N-(2-aminoethyl)-N′-[3-(trimethoxysilyl)propyl]ethylenediamine and analogs thereof having ethoxy or isopropoxy groups instead of methoxy groups on the silicon.

Particularly preferred crosslinking catalysts are organotitanates and amidines.

Preferred organotitanates are in particular bis(ethylacetoacetato)diisobutoxytitanium(IV), bis(ethylacetoacetato)diisopropoxytitanium(IV), bis(acetylacetonato)diisopropoxytitanium(IV), bis(acetylacetonato)diisobutoxytitanium(IV), tris(oxyethyl)amineisopropoxytitanium(IV), bis[tris(oxyethyl)amine]diisopropoxytitanium(IV), bis(2-ethylhexane-1,3-dioxy)titanium(IV), tris[2-((2-aminoethyl)aminoiethoxy]ethoxytitanium(IV), bis(neopentyl(diallyl)oxydiethoxytitanium(IV), titanium(IV) tetrabutoxide, tetra(2-ethylhexyloxy)titanate, tetra(isopropoxy)titanate and polybutyl titanate.

Preferred amidines are in particular 1,8-diazabicyclo[5.4.0]undec-7-ene (DBU), 1,5-diazabicyclo[4.3.0]non-5-ene (DBN), 6-dibutylamino-1,8-diazabicyclo[5.4.0]undec-7-ene; methyl-triazabicyclodecene, guanidines such as tetramethylguanidine, 2-guanidinobenzimidazole, acetylacetoneguanidine, 1,3-di-o-tolylguanidine, 1,3-diphenylguanidine, tolylbiguanidine, 2-tert-butyl-1,1,3,3-tetramethylguanidine; and imidazoles such as N-(3-trimethoxysilylpropyl)-4,5-dihydroimidazole and N-(3-triethoxysilylpropyl)-4,5-dihydroimidazole.

The crosslinking catalyst used is particularly preferably 1,8-diazabicyclo[5.4.0]undec-7-ene (DBU) or 1,5-diazabicyclo[4.3.0]non-5-ene (DBN).

The proportion of crosslinking catalyst in the coating is by preference 0.001% to 5% by weight, preferably 0.005% to 2% by weight, particularly preferably 0.01% to 1% by weight, based on the total weight of the coating composition.

Further Coating Constituents

The coating can additionally contain solvents, fillers, pigments and other coatings additives known in coatings technology.

Examples of suitable solvents are 2-ethylhexanol, acetone, 2-butanone, methyl isobutyl ketone, butyl acetate, ethyl acetate, 1-methoxy-2-propyl acetate (MPA), 3-methoxy-1-butyl acetate, propylene n-butyl ether, toluene, methyl ethyl ketone, xylene, 1,4-dioxane, diacetone alcohol, N-methylpyrrolidone, dimethylacetamide, dimethylformamide, dimethyl sulfoxide, methyl ethyl ketone, solvent naphtha (hydrocarbon mixture) or any mixtures of such solvents.

Preferred solvents in this case are solvents which are standard per se in polyurethane chemistry, such as butyl acetate, ethyl acetate, 1-methoxy-2-propyl acetate (MPA), 3-methoxy-1-butyl acetate, propylene n-butyl ether, toluene, 2-butanone, xylene, 1,4-dioxane, methyl ethyl ketone, N-methylpyrrolidone, dimethylacetamide, dimethylformamide, methyl ethyl ketone, solvent naphtha (hydrocarbon mixture) or any mixtures of such solvents.

Particularly preferred solvents are solvents such as butyl acetate, 1-methoxy-2-propyl acetate (MPA), 3-methoxy-1-butyl acetate, ethyl acetate, propylene n-butyl ether, methyl ethyl ketone, toluene, xylene, solvent naphtha (hydrocarbon mixture) and also mixtures thereof.

The proportion of solvent in the coating is by preference 0.5% to 40% by weight, preferably 1% to 30% by weight, particularly preferably 2% to 25% by weight.

Suitable coatings additives are in particular the matting agents, flame retardants, leveling auxiliaries, wetting and dispersing additives, defoamers, deaerators, antioxidants, light stabilizers, water scavengers, thickeners and thixotropic agents known in coatings technology and as are described for example in the “Lehrbuch der Lacke and Beschichtungen, Band III, Lösemittel, Weichmacher, Additive, Zwischenprodukte” [Textbook on Paints and Coatings, volume III, Solvents, Plasticizers, Additives, Intermediates], H. Kittel, Verlag W. A. Colomb in der Heenemann GmbH, Berlin-Oberschwandorf, 1976, pp. 237-398.

The proportion of coatings additives in the coating is by preference 0.5% to 15% by weight, preferably 1% to 10% by weight, particularly preferably 2% to 7% by weight, based on the total weight of the coating.

Examples of suitable fillers are barite, chalk or talc. Fillers having a barrier effect can also be used, such as for example platelet-form phyllosilicates or sheet aluminosilicates, graphite, aluminum platelets or barrier pigments such as for example iron mica and nanofillers such as for example clays and aluminum silicates. Wherein the fillers can be used alone or in combination.

The proportion of filler in the coating is by preference 1% to 30% by weight, preferably 3% to 20% by weight, particularly preferably 5% to 15% by weight, based on the total weight of the coating.

Suitable pigments are the pigments known in coatings technology, such as for example titanium dioxide, zinc oxide, iron oxides, chromium oxides or carbon blacks.

The proportion of pigments in the coating is by preference 5% to 40% by weight, preferably 10% to 35% by weight, particularly preferably 15% to 30% by weight, based on the total weight of the coating.

An extensive overview of pigments and fillers for coatings can be found in the “Lehrbuch der Lacke and Beschichtungen, Band II, Pigmente, Füllstoffe, Farbstoffe” [Textbook on Paints and Coatings, volume II, Pigments, Fillers, Dyes], H. Kittel, Verlag W.A. Colomb in der Heenemann GmbH, Berlin-Oberschwandorf, 1974, pp. 17-265.

### Preferred Embodiment

In one preferred embodiment, the coating comprises

10% to 80% by weight of the polyurea compound according to the invention,

0.5% to 40% by weight of solvent,

5% to 40% by weight of pigments,

0.5% to 15% by weight of coatings additives,

1% to 30% by weight of filler, and

0.001% to 5% by weight of crosslinking catalyst,

in each case based on the total weight of the coating. The components mentioned preferably add up to 100% by weight.

Use as a Binder

The invention also relates to the use of the compound according to the invention as a binder in a moisture-curing coating. The use of the compound according to the invention preferably serves to improve the development of hardness, in particular to accelerate the development of hardness of the coating. The coating is preferably a moisture-curing coating for the production of a topcoat for an anticorrosion system.

### EXAMPLES

Preparation and Analysis of Trialkoxysilane-Modified Polyurea Compounds

A flask with a thermometer, precision glass stirrer, reflux condenser and dropping funnel was initially charged with polyisocyanate and 1-methoxy-2-propyl acetate (MPA) (approx. 20-25% by weight of the amount of polyisocyanate used) under a nitrogen atmosphere at room temperature. Then, di-n-butylamine was first added dropwise within 20-45 min at room temperature. As a result of the exothermicity of the reaction, the temperature of the reaction mixture rises to 40-50° C. After the theoretically expected isocyanate content had been reached, the reaction mixture was heated to 50° C. If the mixture had a very high viscosity, additional 1-methoxy-2-propyl acetate was added before further reaction. Then, diethyl N-(3-triethoxysilylpropyl)aspartate (prepared according to DE 4237468 A1, example 1) was added dropwise within 60 minutes at 50° C. and stirring was continued until no significant NCO content was detectable any longer according to IR spectroscopy or by means of NCO titration. Gradual addition of further MPA was used to adjust the reaction mixture to a viscosity of 3000 to 4000 mPas at 23° C.

The NCO contents were determined according to DIN EN ISO 11909.

All the viscosity measurements were made with a Physica MCR 51 rheometer from Anton Paar GmbH (Germany) according to DIN EN ISO 3219.

The number- and weight-average molecular weight was determined by gel permeation chromatography (GPC) in tetrahydrofuran at 23° C. according to DIN 55672-1.

The following example compounds were prepared in accordance with the abovementioned preparation process.

### Synthesis Example 1

### According to the Invention

Desmodur XP 2565 is a polyisocyanate based on isophorone diisocyanate with isocyanurate and allophanate groups. NCO content approx. 12.0%.

Desmodur XP 2565 80% in butyl acetate: 349.00 g (1 eq. of NCO)

Di-n-butylamine: 64.55 g (0.5 eq. of amine)

Diethyl N-(3-triethoxysilylpropyl)aspartate: 201.80 g (0.5 eq. of amine)

1-Methoxy-2-propyl acetate (MPA): 153.03 g

Viscosity of the end product: 2810 mPas

Polymer content of the end product: 71%

Number-average molar mass Mₙ according to GPC: 1320 g/mol

Weight-average molar mass M_{w} according to GPC: 1621 g/mol

Silicon content based on solids: 2.57%

Ethoxysilane functionality based on solids: 2.75 eq/kg

### Comparative Example 1

Desmodur N 3300 is a polyisocyanate based on hexamethylene diisocyanate with isocyanurate groups. NCO content approx. 21.8%.

Desmodur N 3300: 333.33 g (1.73 eq. of NCO)

Di-n-butylamine: 134.71 g (1.042 eq. of amine)

Diethyl N-(3-triethoxysilylpropyl)aspartate: 272.90 g (0.687 eq. of amine)

1-Methoxy-2-propyl acetate (MPA): 221.32 g

Viscosity of the end product: 3530 mPas

Polymer content of the end product: 77%

Number-average molar mass Mₙ according to GPC: 1573 g/mol

Weight-average molar mass M_{w} according to GPC: 2139 g/mol

Silicon content based on solids: 2.60%

Ethoxysilane functionality based on solids: 2.78 eq/kg

### Comparative Example 2

Desmodur XP 2580 is a polyisocyanate based on hexamethylene diisocyanate. NCO content approx. 19.5%.

Desmodur XP 2580: 333.33 g (1.547 eq. of NCO)

Di-n-butylamine: 115.04 g (0.889 eq. of amine)

Diethyl N-(3-triethoxysilylpropyl)aspartate: 261.42 g (0.658 eq. of amine)

1-Methoxy-2-propyl acetate (MPA): 145.38 g

Viscosity of the end product: 3950 mPas

Polymer content of the end product: 83%

Number-average molar mass Mₙ according to GPC: 1302 g/mol

Weight-average molar mass M_{w} according to GPC: 1613 g/mol

Silicon content based on solids: 2.60%

Ethoxysilane functionality based on solids: 2.78 eq/kg

### Comparative example 3

Desmodur N 3400 is a polyisocyanate based on hexamethylene diisocyanate with uretdione groups. NCO content approx. 21.8%.

Desmodur N 3400: 342.63 g (1.727 eq. of NCO)

Di-n-butylamine: 134.70 g (1.043 eq. of amine)

Diethyl N-(3-triethoxysilylpropyl)aspartate: 274.87 g (0.687 eq. of amine)

1-Methoxy-2-propyl acetate (MPA): 143.28 g

Viscosity of the end product: 3670 mPas

Polymer content of the end product: 84%

Number-average molar mass Mₙ according to GPC: 1154 g/mol

Weight-average molar mass M_{w} according to GPC: 1514 g/mol

Silicon content based on solids: 2.56%

Ethoxysilane functionality based on solids: 2.74 eq/kg

### Comparative Example 4

Desmodur N 3200 is a polyisocyanate based on hexamethylene diisocyanate with biuret groups. NCO content approx. 23.0%.

Desmodur N 3200: 333.33 g (1.824 eq. of NCO)

Di-n-butyl amine: 145.22 g (1.123 eq. of NCO)

Diethyl N-(3-triethoxysilylpropyl)aspartate: 281.00 g (0.702 eq. of amine)

1-Methoxy-2-propyl acetate (MPA): 280.93 g

Viscosity of the end product: 3300 mPas

Polymer content of the end product: 73%

Number-average molar mass Mₙ according to GPC: 1441 g/mol

Weight-average molar mass M_{w} according to GPC: 2176 g/mol

Silicon content based on solids: 2.59%

Ethoxysilane functionality based on solids: 2.77 eq/kg

### Comparative Example 5

Desmodur N 3900 is a polyisocyanate based on hexamethylene diisocyanate. NCO content approx. 23.5%.

Desmodur N 3900: 333.33 g (1.863 eq. of NCO)

Di-n-butyl amine: 149.53 g (1.156 eq. of amine)

Diethyl N-(3-triethoxysilylpropyl)aspartate: 283.67 g (0.708 eq. of amine)

1-Methoxy-2-propyl acetate (MPA): 216.2 g

Viscosity of the end product: 3770 mPas

Polymer content of the end product: 78%

Number-average molar mass Mₙ according to GPC: 1355 g/mol

Weight-average molar mass M_{w} according to GPC: 1666 g/mol

Silicon content based on solids: 2.59%

Ethoxysilane functionality based on solids: 2.77 eq/kg

The silane-modified compounds of inventive example 1 and comparative examples 1 to 5 were diluted with MPA to a solids content of 70% by weight. 1% by weight of DBU (based on the total amount including solvent) was added to these formulations as curing catalyst. The catalyst-containing formulation was applied with a 120 μm wet film thickness to a dry glass plate using a doctor blade. The glass plate was stored in a climate-controlled cabinet at 23° C. and 50% relative air humidity. The coating is checked for the occurrence of curing after the times given in table 1 below. To this end, the hardness was analyzed using a Konig pendulum damping instrument in accordance with DIN EN ISO 1522:2007-04. A slow pendulum damping in seconds, i.e. a high value in seconds, indicates progressive curing of the silane.

TABLE 1

| | Si density | | | |
|---|---|---|---|---|
| | (% by | Pendulum | Pendulum | Pendulum |
| | weight based | hardness (s) | hardness (s) | hardness (s) |
| STP | on solids) | after 5 h | after 24 h | after 7 d |
| Synthesis | 2.57 | 34 | 122 | 199 |
| example 1 | | | | |
| Comparative | 2.60 | <10 | 36 | 52 |
| example 1 | | | | |
| Comparative | 2.60 | <10 | 15 | 18 |
| example 2 | | | | |
| Comparative | 2.56 | <10 | <10 | <10 |
| example 3 | | | | |
| Comparative | 2.59 | <10 | <10 | 45 |
| example 4 | | | | |
| Comparative | 2.59 | 18 | 18 | 28 |
| example 5 | | | | |

The results clearly show that the compound according to the invention, despite an identical silane density and silane functionality, cures more rapidly than the comparative compounds based on a different polyisocyanate.

Preparation and Analysis of Dialkoxysilane-Modified Polyurea Compounds

The preparation of dialkoxysilane-modified polyurea compounds was effected analogously to the preparation of the trialkoxysilane-modified compounds described above, except that the aminosilane used was diethyl N-(3-diethoxymethylsilyl)aspartate (prepared analogously to DE 4237468 A1, example 1) and that the aminosilane was added before the dialkylamine.

The following compounds were prepared.

### Synthesis Example 2

### According to the Invention

Desmodur XP 2565 80% in butyl acetate: 1047.00 g (3.00 eq. of NCO)

Diethyl N-(3-diethoxymethylsilylpropyl)aspartate: 759.57 g (2.10 eq. of amine)

Di-n-butylamine: 116.32 g (0.90 eq. of amine)

Viscosity of the end product: 3390 mPas

Polymer content of the end product: 73%

Number-average molar mass Mₙ according to GPC: 1420 g/mol

Weight-average molar mass M_{w} according to GPC: 1684 g/mol

Silicon content based on solids: 3.43%

Ethoxysilane functionality based on solids: 2.43 eq/kg

### Comparative Example 6

Desmodur XP 2580: 333.30 g (1.547 eq. of NCO)

Diethyl N-(3-diethoxymethylsilylpropyl)aspartate: 334.57 g (0.925 eq. of amine)

Di-n-butylamine: 134.71 g (0.622 eq. of amine)

1-Methoxy-2-propyl acetate (MPA): 153.24 g

Viscosity of the end product: 3670 mPas

Polymer content of the end product: 83%

Number-average molar mass Mₙ according to GPC: 1382 g/mol

Weight-average molar mass M_{w} according to GPC: 1743 g/mol

Silicon content based on solids: 3.46%

Ethoxysilane functionality based on solids: 2.47 eq/kg

### Comparative Example 7

Desmodur N 3300: 333.33 g (1.730 eq. of NCO)

Diethyl N-(3-diethoxymethylsilylpropyl)aspartate: 349.28 g (0.966 eq. of amine)

Di-n-butyl amine: 98.75 g (0.764 eq. of amine)

1-Methoxy-2-propyl acetate (MPA): 233.39 g

Viscosity of the end product: 4930 mPas

Polymer content of the end product: 77%

Number-average molar mass Mₙ according to GPC: 1807 g/mol

Weight-average molar mass M_{w} according to GPC: 2304 g/mol

Silicon content based on solids: 3.46%

Ethoxysilane functionality based on solids: 2.47 eq/kg

The batches of synthesis example 2 and of comparative examples 6 and 7 were diluted to 70% by weight of solids content as described above with 1% by weight of DBU (based on the total amount including solvent) and knife-coated onto glass plates. Storage and determination of the progression of curing were likewise performed as described. The results are specified in table 2 below.

TABLE 2

| | Si density | | | |
|---|---|---|---|---|
| | (% by | Pendulum | Pendulum | Pendulum |
| | weight based | hardness (s) | hardness (s) | hardness (s) |
| STP | on solids) | after 5 h | after 24 h | after 7 d |
| Synthesis | 3.43 | 11 | 92 | 152 |
| example 2 | | | | |
| Comparative | 3.46 | <10 | 10 | 10 |
| example 6 | | | | |
| Comparative | 3.46 | <10 | 10 | 47 |
| example 7 | | | | |

Here, too, it is apparent that the compound according to the invention, despite an identical silane density and silane functionality, cures substantially more rapidly than the comparative compounds based on a different polyisocyanate.

Comparison of the Viscosities of the Reaction Products of Desmodur XP 2565 with Aspartate Silane and N-(3-triethoxysilylpropyl)butylamine

### Synthesis Example 3

### According to the Invention

A flask with a thermometer, precision glass stirrer, reflux condenser and dropping funnel was initially charged with polyisocyanate and 1-methoxy-2-propyl acetate (MPA) (approx. 20-25% by weight of the amount of polyisocyanate used) under a nitrogen atmosphere at room temperature. This mixture was heated to 55° C. Then, within 2 hours at this temperature diethyl N-(3-triethoxysilylpropyl)aspartate (prepared according to DE 4237468 A1, example 1) was added dropwise and stirring was continued until no significant NCO content was detectable any longer according to IR spectroscopy or by means of NCO titration. Gradual addition of further MPA was used to adjust the reaction mixture to a viscosity of 3000 to 4000 mPas at 23° C.

Desmodur XP 2565 80% in butyl acetate: 875.00 g (2.5 eq. of NCO)

Diethyl N-(3-triethoxysilylpropyl)aspartate: 1017.50 g (2.5 eq. of amine)

1-Methoxy-2-propyl acetate (MPA): 254.4 g

Viscosity of the end product: 3030 mPas

Polymer content of the end product: 80%

Number-average molar mass Mₙ according to GPC: 1583 g/mol

Weight-average molar mass M_{w} according to GPC: 1937 g/mol

Silicon content based on solids: 4.08%

Ethoxysilane functionality based on solids: 4.37 eq/kg

### Comparative Example 8

A flask with a thermometer, precision glass stirrer, reflux condenser and dropping funnel was initially charged with polyisocyanate and 1-methoxy-2-propyl acetate (MPA) (approx. 20-25% by weight of the amount of polyisocyanate used) under a nitrogen atmosphere at room temperature. This mixture was heated to 55° C. Then, within 1 hour at this temperature N-(3-triethoxysilylpropyl)butylamine was added dropwise and stirring was continued until no significant NCO content was detectable any longer according to IR spectroscopy or by means of NCO titration. After the end of the reaction, the reaction mixture was very viscous and was set to a viscosity of about 5000 mPas at 23° C. by means of gradual addition of further MPA.

Desmodur XP 2565 80% in butyl acetate: 261.8 g (0.75 eq. of NCO)

Diethyl N-(3-triethoxysilylpropyl)aspartate: 164.6 g (0.75 eq. of amine)

1-Methoxy-2-propyl acetate (MPA): 79.0 g

Viscosity of the end product: 5240 mPas

Polymer content of the end product: 74%

Number-average molar mass Mₙ according to GPC: 1252 g/mol

Weight-average molar mass M_{w} according to GPC: 1403 g/mol

Silicon content based on solids: 5.62%

Ethoxysilane functionality based on solids: 6.02 eq/kg

The free NCO groups of the Desmodur XP 2565 were completely reacted with an aminosilane in an identical manner for synthesis example 3 and comparative example 8. Synthesis example 3 according to the invention features a more advantageous viscosity compared to comparative example 8. Synthesis example 3 contains 80% polymer and has a viscosity of 3030 mPas, whereas comparative example 8 has a markedly higher viscosity of 5240 mPas with a lower polymer content and thus higher solvent content. The comparative example requires much more solvent for processing than the product according to the invention.

The curing rate is tested as described above with 1% of DBU after knife-coating onto glass.

| | Pendulum | Pendulum |
|---|---|---|
| | hardness (s) | hardness (s) |
| | after 5 h | after 24 h |
| Synthesis | 57 | 172 |
| example 3 | | |
| Comparative | 82 | 145 |
| example 8 | | |

The curing rate of both products is comparable.

Products with di-n-butylamine and 2-ethyl-1-hexanol for comparison

### Synthesis Example 4

### According to the Invention

A flask with a thermometer, precision glass stirrer, reflux condenser and dropping funnel was initially charged with polyisocyanate and 1-methoxy-2-propyl acetate (MPA) (approx. 20-25% by weight of the amount of polyisocyanate used) under a nitrogen atmosphere at room temperature. Then, di-n-butylamine was first added dropwise within 20-45 min at room temperature. As a result of the exothermicity of the reaction, the temperature of the reaction mixture rises to 40-50° C. After the theoretically expected isocyanate content had been reached, the reaction mixture was heated to 50° C. If the mixture had a very high viscosity, additional 1-methoxy-2-propyl acetate was added before further reaction. Then, diethyl N-(3-triethoxysilylpropyl)aspartate (prepared according to DE 4237468 A1, example 1) was added dropwise within 60 minutes at 50° C. and stirring was continued until no significant NCO content was detectable any longer according to IR spectroscopy or by means of NCO titration. Gradual addition of further MPA was used to adjust the reaction mixture to a viscosity of 3000 to 4000 mPas at 23° C.

Desmodur XP 2565 80% in butyl acetate: 187.50 g (0.54 eq. of NCO)

Desmodur N 3300: 50.00 g (0.26 eq. of NCO)

Diethyl N-(3-triethoxysilylpropyl)aspartate: 223.94 g (0.56 eq. of amine)

Di-n-butylamine: 31.02 g (0.24 eq. of amine)

1-Methoxy-2-propyl acetate (MPA): 106.17 g

Viscosity of the end product: 3170 mPas

Polymer content of the end product: 76%

Number-average molar mass Mₙ according to GPC: 1562 g/mol

Weight-average molar mass M_{w} according to GPC: 2013 g/mol

Silicon content based on solids: 3.45%

Ethoxysilane functionality based on solids: 3.69 eq/kg

### Synthesis Example 5

### According to the Invention

A flask with a thermometer, precision glass stirrer, reflux condenser and dropping funnel was initially charged with polyisocyanate and 1-methoxy-2-propyl acetate (MPA) (approx. 20-25% by weight of the amount of polyisocyanate used) under a nitrogen atmosphere at room temperature. The catalyst K-Kat 348 (King Industries, Norwalk, Conn., USA) and 2-ethyl-1-hexanol were added at a temperature of 53° C. and the mixture was stirred at this temperature for 2 hours, until the theoretical NCO content had been reached. After the theoretically expected isocyanate content had been reached, diethyl N-(3-triethoxysilylpropyl)aspartate (prepared according to DE 4237468 A1, example 1) was added dropwise within 90 minutes at the same temperature and stirring was continued until no significant NCO content was detectable any longer according to IR spectroscopy or by means of NCO titration. Gradual addition of further MPA was used to adjust the reaction mixture to a viscosity of 3000 to 4000 mPas at 23° C.

Desmodur XP 2565 80% in butyl acetate: 375.0 g (1.074 eq. of NCO)

Desmodur N 3300 100.00 g (0.516 eq. of NCO)

2-Ethyl-1-hexanol 62.26 g (0.478 eq. of OH)

Diethyl N-(3-triethoxysilylpropyl)aspartate: 223.94 g (1.112 eq. of amine)

1-Methoxy-2-propyl acetate (MPA): 151.4 g

Viscosity of the end product: 3190 mPas

Polymer content of the end product: 80%

Number-average molar mass Mₙ according to GPC: 1698 g/mol

Weight-average molar mass M_{w} according to GPC: 2058 g/mol

Silicon content based on solids: 3.46%

Ethoxysilane functionality based on solids: 3.68 eq/kg

The curing rate is tested as described above with 1% of DBU after knife-coating onto glass.

| | Pendulum | Pendulum |
|---|---|---|
| | hardness (s) | hardness (s) |
| | after 5 h | after 24 h |
| Synthesis | 41 | 136 |
| example 4 | | |
| Synthesis example 5 | 17 | 122 |

The curing kinetics of the two products (di-n-butylamine- or 2-ethyl-1-hexanol-terminated) is comparable.

Use in Three-Layer Construction for Anticorrosion Applications

Analogously to the process described above, the following silane-modified polyurea compound was prepared and tested as a binder in a three-layer construction for anticorrosion applications.

### Synthesis Example 6

### According to the Invention

Desmodur XP 2565 80% in butyl acetate: 436.25 g (1.25 eq. of NCO)

Diethyl N-(3-diethoxymethylsilylpropyl)aspartate: 476.10 g (1.25 eq. of amine)

1-Methoxy-2-propyl acetate (MPA): 187.78 g

Viscosity of the end product: 3170 mPas

Polymer content of the end product: 75%

Number-average molar mass Mₙ according to GPC: 1714 g/mol

Weight-average molar mass M_{w} according to GPC: 2055 g/mol

The compound according to synthesis example 6 was used as a binder for producing a pigmented topcoat the composition of which can be seen in table 3 below.

The topcoat was produced at room temperature by adding component 1 into a cooled vessel (twin-wall vessel with external cooling via cold tap water). Component 2 was added and the resulting mixture was dispersed at approx. 600-800 rpm using a dissolver until homogeneous. Component 3 was then added with slow stirring (approx. 600-800 rpm) and thereafter dispersed at 2800 rpm for 30 minutes.

The topcoats were processed after a ripening time of one day.

TABLE 3

| | | | % by |
|---|---|---|---|
| Component | Feedstock | Weight (g) | weight |
| 1 | Synthesis example 6 | 773.9 g | 54.88 |
| | Disperbyk 161 (wetting | 21.6 | 1.53 |
| | and dispersing additive) | | |
| | Dynasylan VTMO (water scavenger) | 7.5 | 0.53 |
| | Byk 141 (defoamer) | 5.6 | 0.40 |
| | Tinuvin 292 (light stabilizer) | 5.6 | 0.40 |
| 2 | Aerosil R 972 (thixotropic agent) | 10.1 | 0.72 |
| | Bentone SD 2 (thixotropic agent) | 13.6 | 0.96 |
| | MPA (solvent) | 67.5 | 4.79 |
| 3 | Tronox R-KB-4 (pigment) | 365.2 | 25.90 |
| | Barium sulfate EWO (filler) | 139.5 | 9.89 |

Prior to processing, 1% by weight of DBU based on the amount of synthesis example 6 used was added as crosslinking catalyst to the topcoat described above, the mixture was mixed well by hand for 1 min. and then used as topcoat in a multilayer construction on steel. The multilayer construction was produced by spray application and subjected to a condensation water test and a salt spray test.

Spray Application

The spray application was effected using a SATAjet RP 3000 type spray gun with a 1.6 mm SATA spray nozzle at a pressure of approx. 2.1 to 2.2 bar. Coating was effected under the existing ambient climate (slight fluctuations in temperature and air humidity possible). Depending on the solids content of the binder, the coating systems were diluted between 5% to 10% with the solvent that was already present in the coating system. This solvent is usually MPA.

Three-Layer Construction on Steel

First, a one-component PUR basecoat was applied to a steel sheet (blasted to SA 2^{1/2}) by means of the spray application described and was subsequently dried at room temperature. The basecoat used is a one-component PUR zinc dust basecoat according to the guide formulation from Covestro Deutschland AG with the designation RR 5280. After drying this basecoat, for the next layer a polyurethane-containing intermediate coat of the guide formulation from Covestro Deutschland AG with the designation RR 5282 was applied and dried. The topcoat was likewise applied using the spray application described and dried.

Condensation Water Test According to DIN EN ISO 6270-2 CH

Demineralized water was heated to +40° C. and evaporated in a closed testing apparatus. This resulted in a condensing humidity in the testing apparatus of 100%. Heat was released to the outside, resulting in the temperature dropping below the dew point. Water vapor condensed on the samples. The test duration was 1008 h. Interim inspection was performed after defined times. In addition, a final inspection was also performed after the arranged test duration. This involved examining the samples visually for surface changes such as cracks, craters and blistering.

For the three-layer construction on steel described above, no surface changes were detected after 42 days.

Salt Spray Test According to DIN EN ISO 9227 NSS

A 5% sodium chloride solution was sprayed at 35° C. into a closed testing apparatus. The sprayed aerosol resulted in a corrosion-promoting salt mist atmosphere with a condensing humidity of 100% in the testing apparatus.

Testing was effected using a DIN cut. The test duration was 1440 h. Interim inspection was performed after defined times and a check of the sub-film corrosion at the DIN cut was performed at the end of the test duration. There was also a final inspection after the arranged test duration. This involved examining the samples visually for surface changes such as cracks, craters and blistering.

For the three-layer construction on steel described above, no surface changes were detected after 60 days.

1.-15. (canceled)

16. A polyurea compound obtained via reaction
of a polyisocyanate based on isophorone diisocyanate and having isocyanurate and allophanate groups
with an amino silane of general formula (I)
R¹ₐ(R¹O)₍₃₋ₐ₎Si(CH₂)ₙNHCHR²CH₂COOR³ (I)
where the radicals R¹ independently of one another are selected from C₁-C₂₀-alkyl or C₆-C₂₀-aryl,
a is an integer between 0 and 2,
n is an integer between 1 and 4,
R² is selected from H, C₁-C₂₀-alkyl, C₆-C₁₂-aryl and —COOR³, and
R³ in each case is C₁-C₂₀-alkyl.

17. The compound as claimed in claim 16, wherein the compound has a content of free NCO groups of less than 0.2% by weight.

18. The compound as claimed in claim 16, wherein the compound has a silicon content of 0.1% to 5% by weight.

19. The compound as claimed in claim 16, wherein the compound has a number-average molecular weight of 300 to 5000 g/mol.

20. The compound as claimed in claim 16, wherein R² is —COOR³.

21. The compound as claimed in claim 16, wherein R¹ is selected from methyl and ethyl.

22. The compound as claimed in claim 16, wherein a=0 or 1.

23. The compound as claimed in claim 16, wherein the compound additionally has urea and/or urethane groups obtained by reaction of the polyisocyanate with a dialkylamine or an alcohol.

24. The compound as claimed in claim 23, wherein the dialkylamine is a compound of the formula NH(R⁴)₂ and R⁴ in each case is C₁-C₆-alkyl.

25. A process for preparing a polyurea compound by
a) providing a polyisocyanate based on isophorone diisocyanate and having isocyanurate and allophanate groups,
b) reacting at least a portion of the NCO groups of the polyisocyanate with an aminosilane of general formula (I)
R¹ₐ(R¹O)₍₃₋ₐ₎Si(CH₂)ₙNHCHR²CH₂COOR³ (I)
where the radicals R¹ independently of one another are selected from C₁-C₂₀-alkyl or C₆-C₂₀-aryl,
a is an integer between 0 and 2,
n is an integer between 1 and 4,
R² is selected from H, C₁-C₂₀-alkyl, C₆-C₁₂-aryl and —COOR³, and
R³ in each case is C₁-C₂₀-alkyl,
c) optionally reacting a portion of the NCO groups of the polyisocyanate with a dialkylamine or an alcohol,
wherein steps b) and c) can be performed simultaneously or in succession in any desired sequence.

26. A moisture-curing coating comprising the compound as claimed in claim 16 and a crosslinking catalyst.

27. The coating as claimed in claim 26, comprising
10% to 80% by weight of the compound,
0.5% to 40% by weight of solvent,
5% to 40% by weight of color pigments,
0.5% to 15% by weight of coatings additives,
1% to 30% by weight of filler, and
0.001% to 5% by weight of crosslinking catalyst,
in each case based on the total weight of the coating.

28. A method comprising utilizing the compound as claimed in claim 16 as a binder for a moisture-curing coating.

29. The method as claimed in claim 28, wherein the binder improves the development of hardness of the coating.

30. The method as claimed in claim 28, wherein the binder serves to produce a topcoat in an anticorrosion system.
